(19) United States
(12) Patent Application Publication
(10) Pub. No.: US 2020/0125399 A1
(43) Pub. Date: Apr. 23, 2020

(54) PROCESS MONITORING DEVICE, PROCESS MONITORING METHOD, AND COMPUTER READABLE MEDIUM

(71) Applicant: Mitsubishi Electric Corporation, Tokyo (JP)

(72) Inventors: Masahiro DEGUCHI, Tokyo (JP); Mitsuo SHIMOTANI, Tokyo (JP); Tetsuji FUJISAKI, Tokyo (JP); Shu MURAYAMA, Tokyo (JP); Hirotaka MOTAI, Tokyo (JP)

(73) Assignee: Mitsubishi Electric Corporation, Tokyo (JP)

(21) Appl. No.: 15/781,020

(22) PCT Filed: Jan. 27, 2016
(86) PCT No.: PCT/JP2016/052357

§ 371 Date: Jun. 1, 2018

(51) Int. Cl. G06F 9/48; G06F 11/30; G06F 11/34

(52) U.S. Cl. CPC G06F 9/4881; G06F 11/3495; G06F 11/3024

(57) ABSTRACT

A process monitoring device has a sending process to send communication data periodically and has a receiving process to receive the sent communication data. The receiving process includes a monitoring thread to write monitoring data in a memory at every reference interval. The sending process includes an acquiring thread to acquire the monitoring data from the memory and a sending thread to send the monitoring data to the receiving process as additional data together with the communication data. The monitoring thread judges a state of the sending process depending on how many times ago the monitoring data, which the additional data is, was generated.

### TECHNICAL FIELD

The present invention relates to a technique for monitoring an abnormality in a process that is executed by a computer.

### BACKGROUND ART

In a computer, such as one serving as a car navigation system, applications that utilize various kinds of sensors operate in a complex manner by using communication processes that communicate with each other.

In such a computer, when sensor data, by which periodic communication occurs, loses its periodicity, and when sensor data to be communicated is incorrect even though its periodicity is not lost, a receiving process that is a communication process on a sensor data receiving side is not performed correctly and is failed. In this situation, it is difficult to determine whether the cause of the failure is in the receiving process or in a sending process that is a communication process on a sensor data sending side. Besides, when it is determined that the cause is in the sending process, it is difficult for the receiving process to know which thread of the sending process is affecting.

Thus, in analysis of the cause of the generated failure, the receiving process cannot know the cause in the sending process, and it takes a long time for the receiving process to analyze the cause.

PTL 1 discloses monitoring of the operation state by operating monitoring processes in addition to a sending process and a receiving process and by making the monitoring processes communicate with each other.

### CITATION LIST

### Patent Literature

PTL 1: JP-A-2009-157944

### SUMMARY OF INVENTION

### Technical Problem

According to PTL 1, the number of processes is increased since the monitoring processes are operated in addition to processes that execute actual communication, and therefore, management is complicated. Although the monitoring processes should have higher reliability than the other processes, the monitoring processes for monitoring communication processes that operate in a complicated manner tend to be very large in scale and be difficult to have high reliability.

An object of the invention is to enable a receiving process side to detect an abnormality in a sending process by an easy method.

### Solution to Problem

A process monitoring device according to the present invention includes:

a sending process to send communication data periodically; and

a receiving process to receive the communication data sent by the sending process,

wherein the receiving process includes a monitoring thread to generate monitoring data at every reference interval and to output the generated monitoring data to a memory,

wherein the sending process includes

an acquiring thread to acquire the monitoring data from the memory, and

a sending thread to send the monitoring data acquired by the acquiring thread, to the receiving process as additional data together with the communication data, and

wherein the monitoring thread judges a state of the sending process depending on how many times ago the monitoring data, which the additional data sent by the sending thread is, was generated.

### Advantageous Effects of Invention

According to the invention, the monitoring thread that operates in the receiving process judges the state of the sending process depending on how many times ago the monitoring data, which the additional data sent by the sending thread is, was generated. This enables the receiving process side to detect an abnormality in the sending process without operating a monitoring process in addition to the sending process and the receiving process.

### BRIEF DESCRIPTION OF DRAWINGS

FIG. 1 is a configuration diagram of a process monitoring device 10 according to an embodiment 1.

FIG. 2 is an explanatory diagram of processes 111 according to the embodiment 1.

FIG. 3 is a process flowchart illustrating a basic operation of a sending process 20 and a receiving process 30 according to the embodiment 1.

FIG. 4 is an explanatory diagram of monitoring data 42 according to the embodiment 1.

FIG. 5 is a process flowchart illustrating operations of the sending process 20 and the receiving process 30 according to the embodiment 1 when the sending process 20 is normal.

FIG. 6 is a process flowchart illustrating the operations of the sending process 20 and the receiving process 30 according to the embodiment 1 when the sending process 20 is abnormal.

FIG. 7 is an explanatory diagram of processes 111 according to an embodiment 2.

FIG. 8 is a process flowchart illustrating an operation when a sending process 20 according to the embodiment 2 was judged as being abnormal.

FIG. 9 is a process flowchart illustrating an operation performed while steps S213 to S215 in FIG. 8 according to the embodiment 2 are repeatedly executed.

FIG. 10 is an explanatory diagram of processes 111 according to an embodiment 3.

FIG. 11 is an explanatory diagram of a ratio of a sending process 20 according to the embodiment 3.

FIG. 12 is an explanatory diagram of a threshold value of the sending process 20 according to the embodiment 3.

### DESCRIPTION OF EMBODIMENTS

### Embodiment 1

### Description of the Configuration

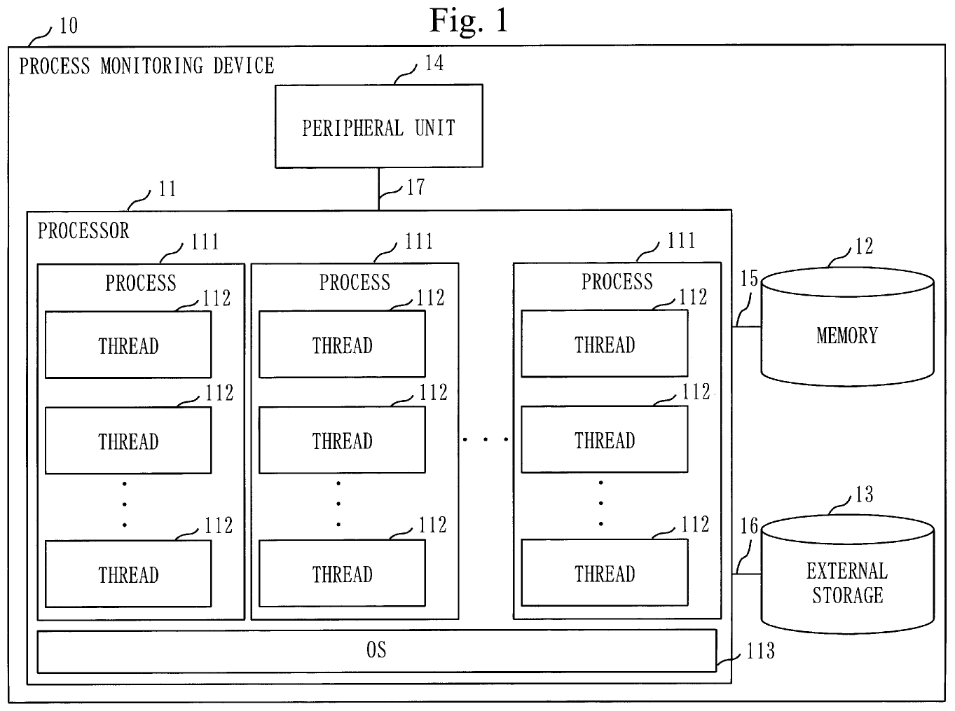

The configuration of a process monitoring device 10 according to the embodiment 1 will be described with reference to FIG. 1.

The process monitoring device 10 is a computer.

The process monitoring device 10 includes a processor 11, a memory 12, an external storage 13, and a peripheral unit 14 as hardware. The processor 11 is connected to other pieces of hardware via signal lines 15 to 17 and controls these other pieces of hardware.

The process monitoring device 10 has multiple processes 111. Each of the processes 111 includes multiple threads 112. Each of the processes 111 operates on an OS 113.

The external storage 13 stores programs for executing each of the processes 111 and the OS 113. The program for the OS 113 is loaded into the memory 12, and is read and executed by the processor 11. Then, the program for each of the processes 111 is loaded into the memory 12, is read by the processor 11, and is executed on the OS 113 by the processor 11. Thus, each of the threads 112 of the processes 111 is executed.

The processor 11 is an integrated circuit (IC) that performs processing. The processor 11 is, specifically, a central processing unit (CPU), a digital signal processor (DSP), or a graphics processing unit (GPU).

The memory 12 is, specifically, a random access memory (RAM).

The external storage 13 is, specifically, a hard disk drive (HDD). The external storage 13 may also be a portable storage medium, such as a secure digital (SD) memory card, a compact flash (CF), a NAND flash, a flexible disk, an optical disc, a compact disc, a blue-ray (registered trademark) disc, or a DVD.

The peripheral unit 14 is a unit such as a global positioning system (GPS) receiver or a gyro sensor. The GPS receiver is a unit that receives radio waves including positioning data from a GPS satellite. The gyro sensor is a unit that measures acceleration based on angular velocity.

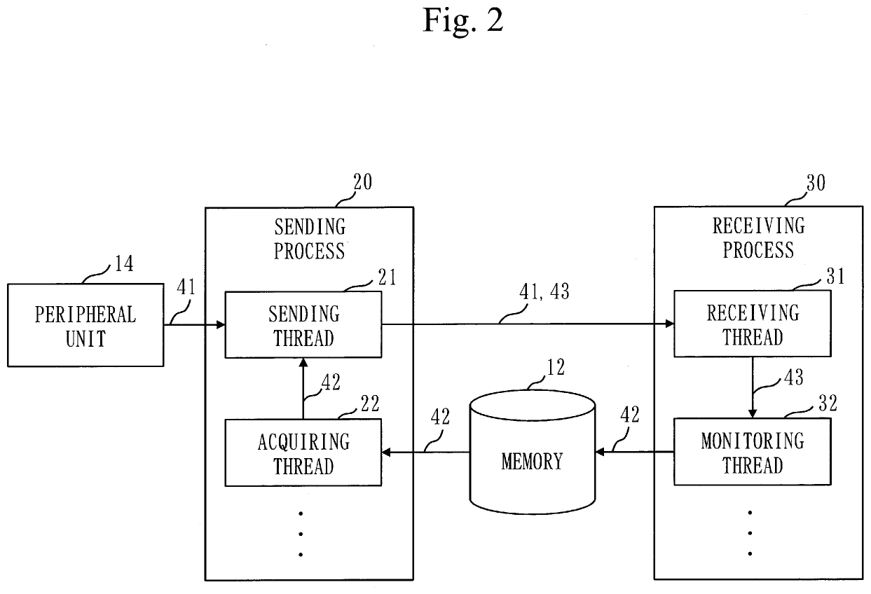

The configuration of the processes 111 according to the embodiment 1 will be described with reference to FIG. 2.

The processes 111 include a sending process 20 and a receiving process 30. The sending process 20 is a process that periodically acquires communication data 41 from the peripheral unit 14 and sends the acquired communication data 41 to the receiving process 30. The receiving process 30 is a process that receives the communication data 41 sent by the sending process 20 and performs processing.

The communication data 41 is, specifically, positioning data when the peripheral unit 14 is the GPS receiver, or acceleration when the peripheral unit 14 is the gyro sensor.

The sending process 20 includes multiple threads 112 that include a sending thread 21 and an acquiring thread 22. The sending thread 21 is a thread 112 that sends monitoring data 42, which is acquired by the acquiring thread 22, to the receiving process 30 as additional data 43 together with the communication data 41. The acquiring thread 22 is a thread 112 that acquires the monitoring data 42 from the memory 12 at every reference interval. The acquiring thread 22 is the thread 112 that operates at the lowest operation priority among the multiple threads 112 included in the sending process 20.

The receiving process 30 includes multiple threads 112 that include a receiving thread 31 and a monitoring thread 32. The receiving thread 31 is a thread 112 that receives the communication data 41 and the additional data 43 sent from the sending thread 21. The monitoring thread 32 is a thread 112 that generates the monitoring data 42 at every reference interval and that outputs the generated monitoring data 42 to the memory 12. The monitoring thread 32 is the thread 112 that judges the state of the sending process 20 depending on how many times ago the monitoring data 42, which the additional data 43 sent by the sending thread 21 is, was generated so as to be.

The monitoring data 42 is data that has a different value each time the monitoring data 42 is generated. In the embodiment 1, the monitoring data 42 is increment data to which 1 is added each time the monitoring data 42 is generated.

In the embodiment 1, the monitoring data 42 is output to the memory 12. However, the monitoring data 42 may be output to a shared area of a memory of another type, such as a cache memory or a register, that is provided in the processor 11.

### Description of Operation

An operation of the process monitoring device 10 according to the embodiment 1 will be described with reference to FIGS. 2 to 6.

The operation of the process monitoring device 10 according to the embodiment 1 is equivalent to a process monitoring method according to the embodiment 1. The operation of the process monitoring device 10 according to the embodiment 1 is also equivalent to a process of a process monitoring program according to the embodiment 1.

A basic operation of the sending process 20 and the receiving process 30 according to the embodiment 1 will be described with reference to FIGS. 2 to 4.

The sending process 20 and the receiving process 30 repeat processes in steps S101 to S103 at every reference interval. The reference interval is an interval within a period with which the sending process 20 sends the communication data 41. It is assumed that the reference interval of the embodiment 1 is equal to the period with which the sending process 20 sends the communication data 41.

In step S101, the monitoring thread 32 generates the monitoring data 42. Specifically, the monitoring thread 32 generates the monitoring data 42 by adding 1 to current monitoring data 42. Then, in step S102, the monitoring thread 32 outputs the monitoring data 42 generated in step S101, to the memory 12. Specifically, the monitoring thread 32 writes the monitoring data 42 in a shared area of the memory 12, to which the sending process 20 and the receiving process 30 are accessible.

In response to this, in step S103, the acquiring thread 22 acquires the monitoring data 42 output in step S102, from the memory 12. Specifically, the acquiring thread 22 reads the monitoring data 42 from the shared area.

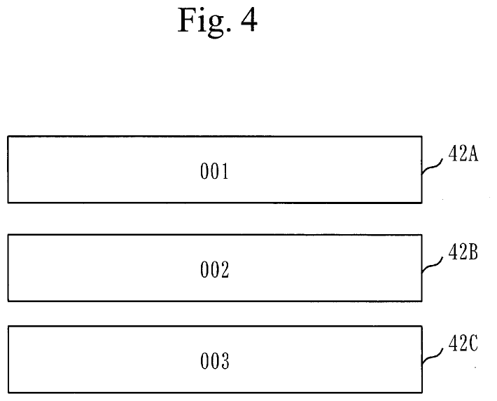

Herein, as illustrated in FIG. 4, monitoring data 42A having a value “001” is generated as the monitoring data 42 in step S101 at the first time. In step S101 at the second time, monitoring data 42B having a value “002” is generated as the monitoring data 42. In step S101 at the third time, monitoring data 42C having a value “003” is generated as the monitoring data 42.

An operation of the sending process 20 and the receiving process 30 according to the embodiment 1 when the sending process 20 is normal will be described with reference to FIGS. 2, 4, and 5.

In step S101, the monitoring thread 32 generates the monitoring data 42A. In step S102, the monitoring thread 32 outputs the monitoring data 42A generated in step S101, to the memory 12. In step S103, the acquiring thread 22 acquires the monitoring data 42A output in step S102, from the memory 12.

In step S104, the sending thread 21 acquires the monitoring data 42A acquired in step S103. Specifically, the acquiring thread 22 writes the monitoring data 42A in an area of the memory 12 for the sending process 20 in step S103, and the sending thread 21 reads this monitoring data 42 in step S104. In step S105, the sending thread 21 adds the monitoring data 42A acquired in step S104, to the communication data 41 as the additional data 43. In step S106, the sending thread 21 sends the communication data 41 added with the additional data 43 to the receiving process 30. Specifically, the sending thread 21 transfers the communication data 41 added with the additional data 43 to the receiving process 30 via interprocess communication.

In step S107, the receiving thread 31 receives the communication data 41 sent in step S106. In step S108, the receiving thread 31 extracts the additional data 43 from the communication data 41 received in step S107. In step S109, the receiving thread 31 transfers the additional data 43 to the monitoring thread 32 and requests check of the state of the sending process 20.

In step S110, the monitoring thread 32 checks the state of the sending process 20 based on the additional data 43 transferred in step S109.

Specifically, the monitoring thread 32 judges the state of the sending process 20 depending on how many times ago the monitoring data 42, which the additional data 43 is, was generated. In the embodiment 1, when the additional data 43 is monitoring data 42 that was generated in the most recent two times, the sending process 20 is judged as being normal. Otherwise, when the additional data 43 is monitoring data 42 that was generated at a time prior to the most recent two times, the sending process 20 is judged as being abnormal. Then, in the embodiment 1, the monitoring thread 32 judges the sending process 20 as being normal when a difference between the value of the additional data 43 and the value of the latest monitoring data 42 is 0 or 1. Otherwise, the monitoring thread 32 judges the sending process 20 as being abnormal when the difference is 2 or larger.

In other words, the monitoring thread 32 specifies a delay time of the sending process 20 depending on how many times ago the monitoring data 42, which the additional data 43 is, was generated. When the specified delay time is within a prescribed value, the sending process 20 is judged as being normal. Otherwise, when the delay time exceeds the prescribed value, the sending process 20 is judged as being abnormal. This is because when the delay time exceeds the prescribed value, there is a probability of not correctly sending the communication data 41 periodically.

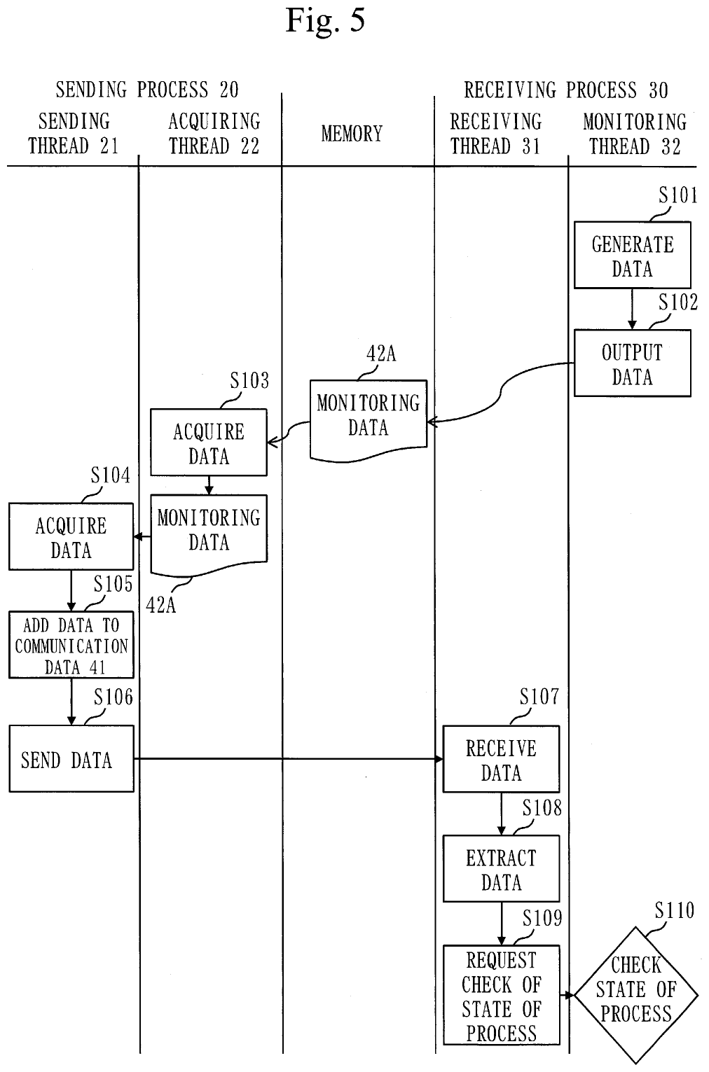

In FIG. 5, the additional data 43 is the monitoring data 42A generated at the most recent time. Thus, the difference between the value of the additional data 43 and the value of the monitoring data 42A generated at the most recent time is 0 (zero). As a result, the sending process 20 is judged as being normal.

An operation of the sending process 20 and the receiving process 30 according to the embodiment 1 when the sending process 20 is abnormal will be described with reference to FIGS. 2, 4, and 6.

In step S101, the monitoring thread 32 generates the monitoring data 42A. In step S102, the monitoring thread 32 outputs the monitoring data 42A generated in step S101, to the memory 12. In step S103, the acquiring thread 22 acquires the monitoring data 42A output in step S102, from the memory 12.

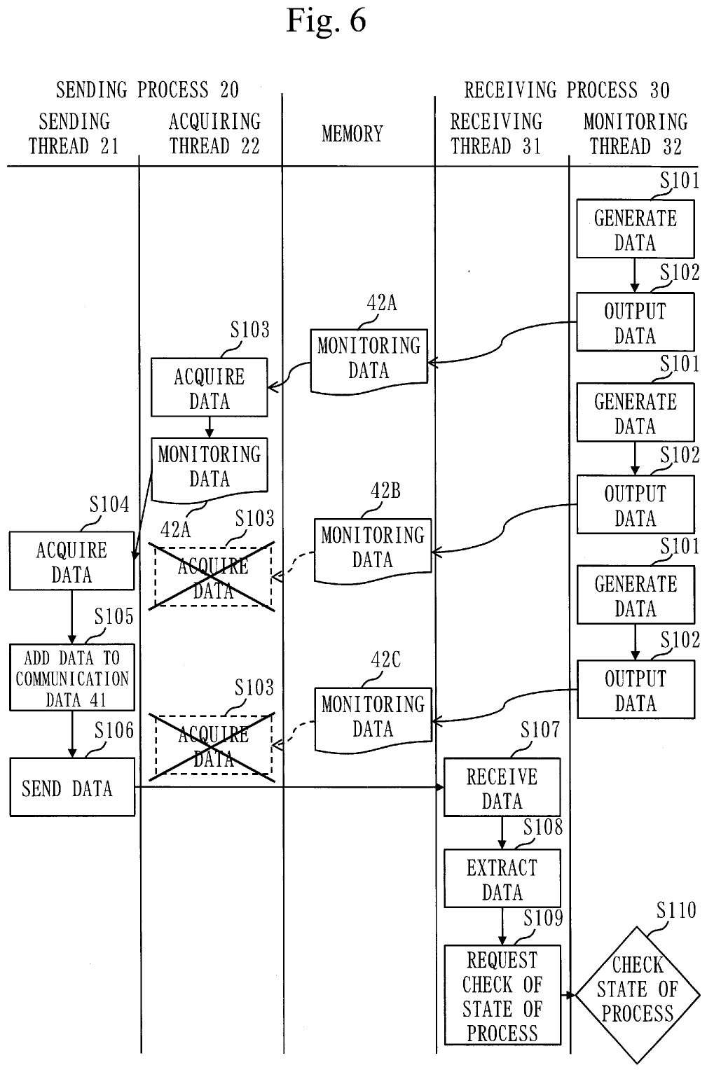

After the reference interval has passed, the monitoring thread 32 generates the monitoring data 42B in step S101 again. In step S102, the monitoring thread 32 outputs the monitoring data 42B generated in step S101, to the memory 12. However, in FIG. 6, the use rate of the processor 11 by the sending process 20 is extraordinary. Thus, the acquiring thread 22, of which the operation priority is the lowest among the threads 112 operating in the sending process 20, is not in a sufficiently operatable state. This causes the acquiring thread 22 to fail to acquire the monitoring data 42B in step S103.

After the reference interval has passed, the monitoring thread 32 generates the monitoring data 42C in step S101 again. In step S102, the monitoring thread 32 outputs the monitoring data 42C generated in step S101, to the memory 12. However, in FIG. 6, the acquiring thread 22 fails to acquire the monitoring data 42C in step S103.

In step S104, the sending thread 21 acquires the monitoring data 42A acquired in step S103. Herein, since the monitoring data 42B and the monitoring data 42C are not yet acquired, the most recently acquired monitoring data 42 is the monitoring data 42A. In step S105, the sending thread 21 adds the monitoring data 42A acquired in step S104, to the communication data 41 as the additional data 43. In step S106, the sending thread 21 sends the communication data 41 added with the additional data 43, to the receiving process 30.

In step S107, the receiving thread 31 receives the communication data 41 sent in step S106. In step S108, the receiving thread 31 extracts the additional data 43 from the communication data 41 received in step S107. In step S109, the receiving thread 31 transfers the additional data 43 to the monitoring thread 32 and requests check of the state of the sending process 20.

In step S110, the monitoring thread 32 checks the state of the sending process 20 based on the additional data 43 that is transferred in step S109.

In FIG. 6, the additional data 43 is the monitoring data 42A that was generated two times ago. Thus, a difference between the value of the additional data 43 and the value of the monitoring data 42C generated at the most recent time is 2. As a result, the sending process 20 is judged as being abnormal. When judging the sending process 20 as being abnormal, the monitoring thread 32 records the result in a log and executes a process for shifting to fall back operation.

### Effects of the Embodiment 1

As described above, in the process monitoring device 10 according to the embodiment 1, the receiving process 30 outputs the monitoring data 42 to the memory 12 at every reference interval, and the monitoring data 42 is acquired by the sending process 20. Then, the receiving process 30 compares the additional data 43, which is the monitoring data 42 received from the sending process 20, with the most recent monitoring data 42. Thus, in the process monitoring device 10, the receiving process 30 can detect an abnormality in the sending process 20 without operating a monitoring process in addition to the sending process 20 and the receiving process 30.

In particular, in the process monitoring device 10 according to the embodiment 1, the acquiring thread 22 is operated at the lowest priority among the threads 112 operating in the sending process 20. Thus, when some failure occurs in the sending process 20, the probability that the acquiring thread 22 is first affected is high. Thus, an abnormality in the sending process 20 can be early detected.

When an abnormality is detected, this result is recorded in a log. This facilitates identification and isolation of the cause of the abnormality.

In the above description, one process 111 serves as the sending process 20, and another process 111 serves as the receiving process 30. However, in some cases, one process 111 may serve as both the sending process 20 and the receiving process 30, and another process 111 may serve as both the sending process 20 and the receiving process 30. That is, in such cases, the two processes 111 send the communication data 41 to each other.

Under such a situation, each of the two processes 111 includes the sending thread 21, the acquiring thread 22, the receiving thread 31, and the monitoring thread 32 so as to monitor their states each other.

### Embodiment 2

An embodiment 2 differs from the embodiment 1 in changing the priority of the acquiring thread 22 when an abnormality is detected. This difference will be described in the embodiment 2.

### Description of Configuration

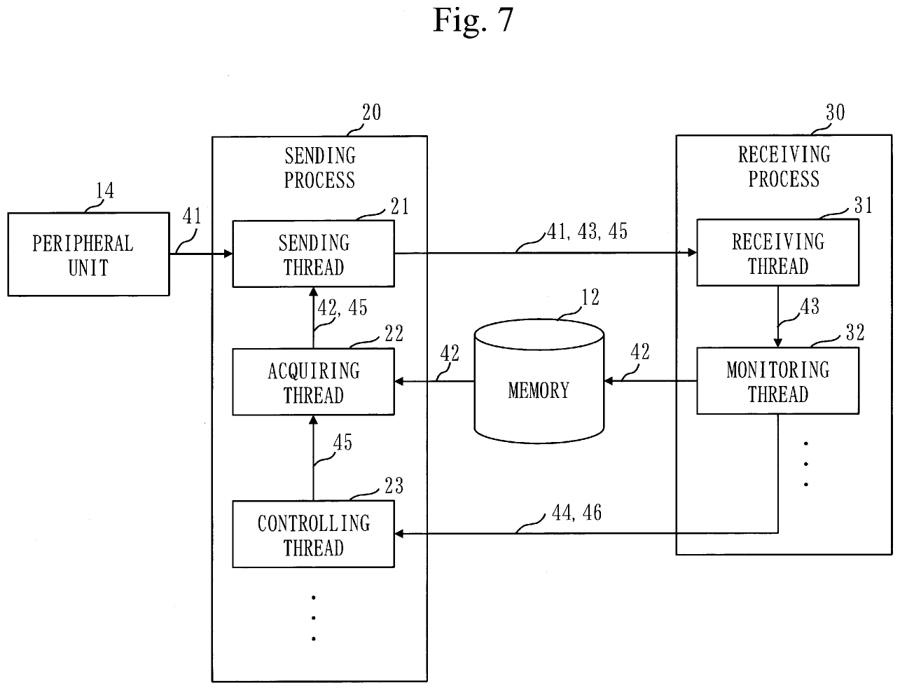

The configuration of processes 111 according to the embodiment 2 will be described with reference to FIG. 7.

A sending process 20 includes a controlling thread 23 in addition to the threads 112 illustrated in FIG. 2. The controlling thread 23 is a thread 112 that gradually increases the operation priority of the acquiring thread 22 until the monitoring thread 32 sends termination information 46 when the monitoring thread 32 sends change information 44. The controlling thread 23 is the thread 112 that operates at the highest operation priority among the threads 112 operated in the sending process 20.

When sending the communication data 41 after the change information 44 is sent, the sending thread 21 adds priority information 45 indicating the operation priority, to the communication data 41.

When judging the sending process 20 as being abnormal, the monitoring thread 32 sends the change information 44 to the sending process 20. Moreover, when judging the sending process 20 as being normal after judging the sending process 20 as being abnormal, the monitoring thread 32 sends the termination information 46 to the sending process 20.

### Description of Operation

An operation of a process monitoring device 10 according to the embodiment 2 will be described with reference to FIGS. 7 to 9.

The operation of the process monitoring device 10 according to the embodiment 2 is equivalent to a process monitoring method according to the embodiment 2. The operation of the process monitoring device 10 according to the embodiment 2 is also equivalent to a process of a process monitoring program according to the embodiment 2.

An operation of the sending process 20 and the receiving process 30 according to the embodiment 2 when the sending process 20 is abnormal will be described with reference to FIGS. 7 to 9.

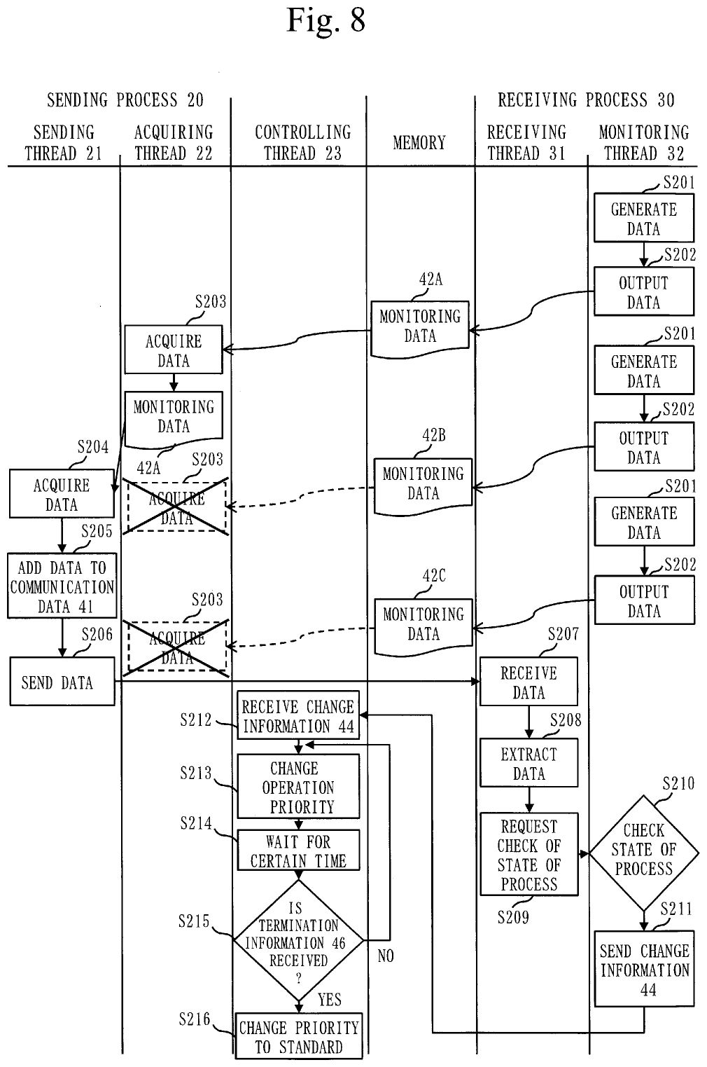

First, an operation in a case in which the sending process 20 is judged as being abnormal will be described with reference to FIG. 8. The operation in steps S201 to S210 illustrated in FIG. 8 is the same as the operation in steps S101 to S110 illustrated in FIG. 6. That is, the monitoring thread 32 judges the sending process 20 as being abnormal in step S210.

When judging the sending process 20 as being abnormal, the monitoring thread 32 sends the change information 44 to the sending process 20 in step S211. In step S212, the controlling thread 23 receives the change information 44 sent in step S211. In step S213, the controlling thread 23 increases the operation priority of the acquiring thread 22 by one.

After waiting for a reference time in step S214, the controlling thread 23 judges whether it receives the termination information 46 in step S215. The reference time is longer than a period with which the sending process 20 sends the communication data 41. While the controlling thread 23 waits for the reference time, the sending process 20 continues sending the communication data 41 to the receiving process 30 periodically.

When not receiving the termination information 46, the controlling thread 23 returns the process to step S213 and further increases the operation priority of the acquiring thread 22 by one. Otherwise, when receiving the termination information 46, the controlling thread 23 advances the process to step S216 and restores the operation priority of the acquiring thread 22 to the lowest, which is the normal priority.

As the operation priority of the acquiring thread 22 is increased one by one, at a time point when this operation priority is higher than the operation priority of the thread 112 having failure, the acquiring thread 22 can normally acquire the monitoring data 42. Thus, until the operation priority of the acquiring thread 22 becomes higher than that of the thread 112 having the failure, steps S213 to S215 in FIG. 8 are executed repeatedly.

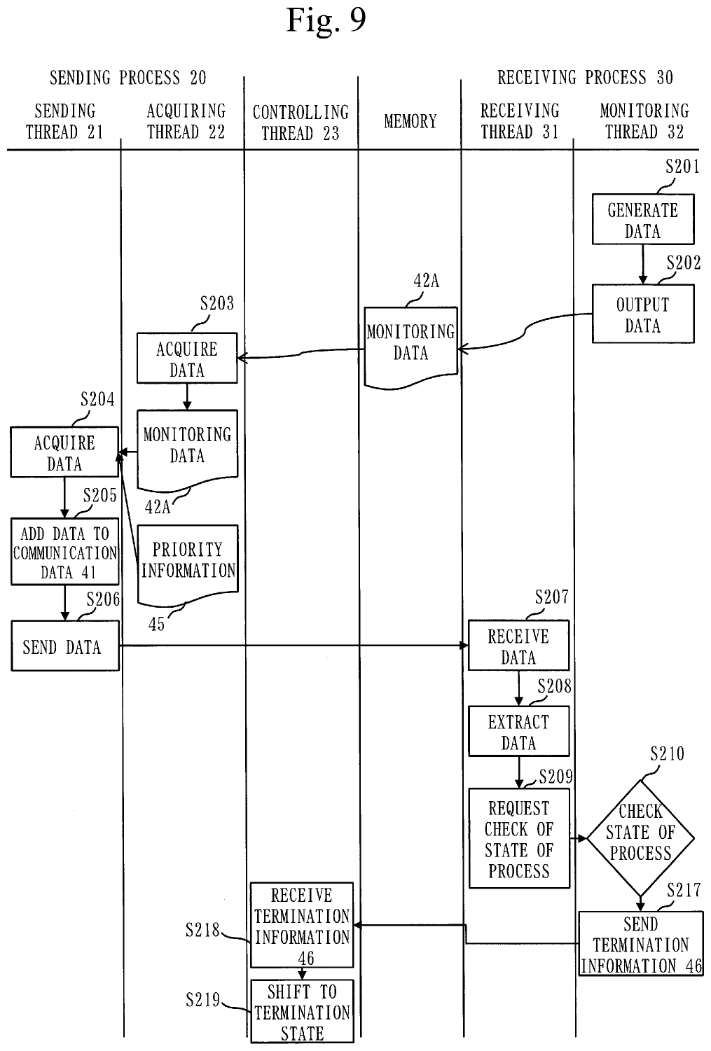

Next, an operation that is performed while steps S213 to S215 in FIG. 8 are executed repeatedly will be described with reference to FIG. 9. The operation in steps S201 to S210 is the same as the operation in steps S101 to S110 illustrated in FIG. 5. That is, the monitoring thread 32 judges the sending process 20 as being normal in step S210.

It should be noted that, in step S204, the sending thread 21 acquires the priority information 45 indicating the operation priority of the acquiring thread 22 in addition to the monitoring data 42. Specifically, the sending thread 21 acquires the priority information 45 from the acquiring thread 22 when reading the monitoring data 42.

When judging the sending process 20 as being normal, the monitoring thread 32 sends the termination information 46 to the controlling thread 23 in step S217 in FIG. 9. The controlling thread 23 receives the termination information 46 in step S218. Then, the controlling thread 23 shifts to a termination state in step S219. Thus, it is judged that the termination information 46 is received in step S215 in FIG. 8, and the operation priority is restored to the lowest in step S216.

### Effects of the Embodiment 2

As described above, in the process monitoring device 10 according to the embodiment 2, when the sending process 20 is judged as being abnormal, the operation priority of the acquiring thread 22 is gradually increased. Then, at the time point when the operation priority of the acquiring thread 22 is higher than that of the thread 112 having the failure, the acquiring thread 22 can normally acquire the monitoring data 42. Accordingly, the receiving process 30 can identify that a failure occurs in a thread 112 of which the operation priority is one lower than the priority indicated by the priority information 45 that was received together with the additional data 43 judged as being normal.

Moreover, the monitoring thread 32 sends the termination information 46 to the sending process 20. Thus, the sending process 20 can identify that a failure occurs in a thread 112 of which the operation priority is one lower than the operation priority at the time point when receiving the termination information 46.

### Embodiment 3

In the embodiments 1 and 2, the receiving process 30 monitors the state of the sending process 20. That is, the process 111 that monitors and the process 111 that is monitored have a one-to-one relationship therebetween. An embodiment 3 differs from the embodiments 1 and 2 in monitoring the states of multiple sending processes 20 by the receiving process 30. That is, the embodiment 3 differs from the embodiments 1 and 2 in that the process 111 that monitors and the processes 111 that are monitored have a one-to-N relationship therebetween (N is an integer of 2 or larger). This difference will be described in the embodiment 3.

It should be noted that a configuration obtained by adding functions to the embodiment 1 will be described in the embodiment 3. However, these functions can also be added to the embodiment 2.

### Description of Configuration

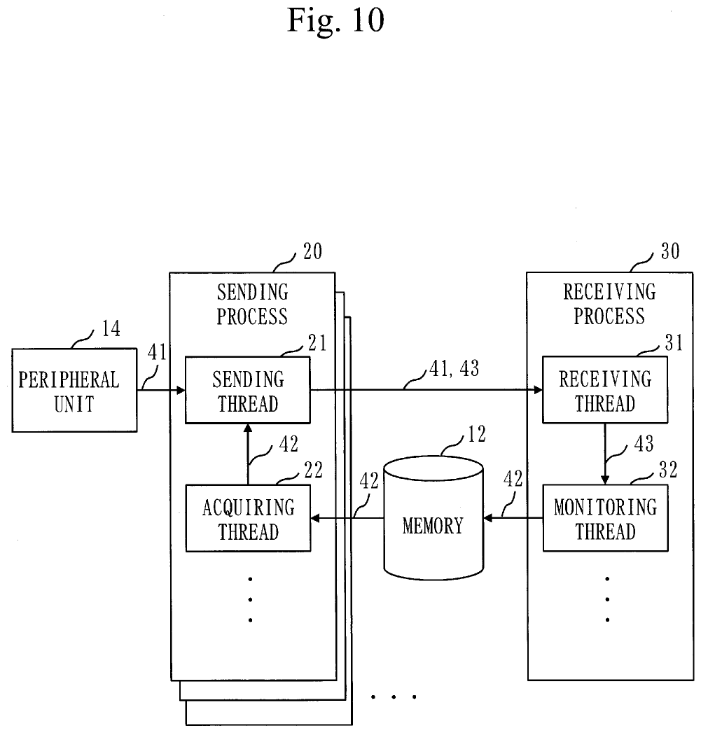

The configuration of processes 111 according to the embodiment 3 will be described with reference to FIG. 10.

The processes 111 include multiple sending processes 20 and a receiving process 30. Each of the sending processes 20 is a process that periodically acquires communication data 41 from a peripheral unit 14 and sends the acquired communication data 41 to the receiving process 30. The period is defined with respect to each of the sending processes 20. The receiving process 30 is a process that receives the communication data 41 sent by each of the sending processes 20 and performs processing.

### Description of Operation

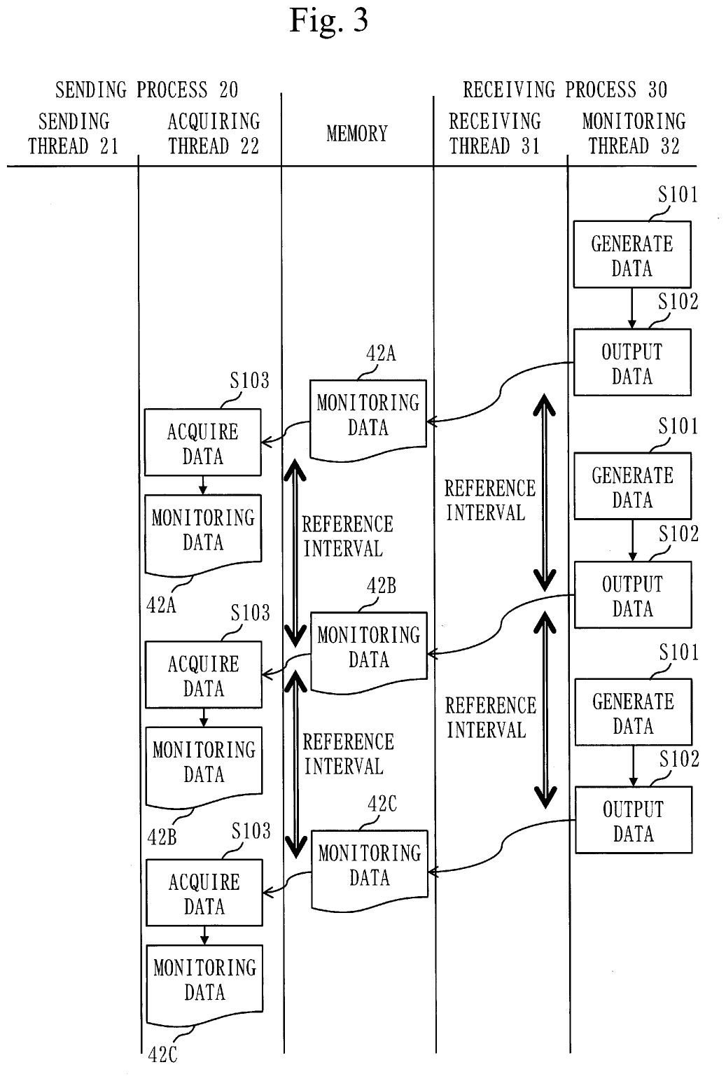

An operation of a process monitoring device 10 according to the embodiment 3 will be described with reference to FIGS. 3, 5, 10, 11, and 12.

The operation of the process monitoring device 10 according to the embodiment 3 is equivalent to a process monitoring method according to the embodiment 3. The operation of the process monitoring device 10 according to the embodiment 3 is also equivalent to a process of a process monitoring program according to the embodiment 3.

As illustrated in FIG. 3, the receiving process 30 repeats the processes from steps S101 to step S103 in conjunction with each of the sending processes 20 at every reference interval. It is assumed that the reference interval in the embodiment 3 is the greatest common divisor of the periods defined respectively for the sending processes 20.

Specifically, it is assumed that the sending processes 20 include a sending process 20Y and a sending process 20Z. It is assumed that the period of the sending process 20Y is 6 ms (milliseconds), and that the period of the sending process 20Z is 9 ms. In this case, the reference interval is 3 ms.

In step S110 in FIG. 5, the monitoring thread 32 judges the state of each of the sending processes 20. At this time, the monitoring thread 32 sets a value of “period of the sending process 20/reference interval” as a ratio for each of the sending processes 20. Then, in the condition in which the state is judged as being normal when a difference between the value of the additional data 43 and the value of the monitoring data 42 is a reference value or less, the monitoring thread 32 sets a value as a threshold value by multiplying the reference value by the ratio.

The reference value is, as described above, a value used as a reference to be compared with the difference between the value of the additional data 43 and the value of the monitoring data 42 to judge whether the state is normal. The reference value is determined in advance and is stored in the memory 12 or the like. In the embodiment 1, when the difference between the value of the additional data 43 and the value of the most recent monitoring data 42 is 0 or 1, the state is judged as being normal. That is, in the embodiment 1, the state is judged as being normal when the difference is 1 or less, and thus, the reference value is 1.

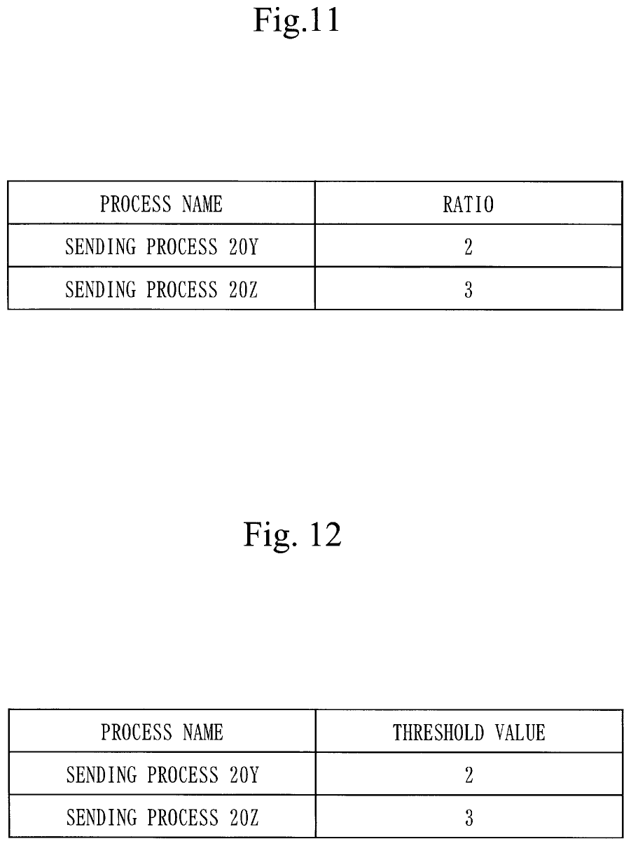

Specifically, as illustrated in FIG. 11, in the case of the sending process 20Y, the ratio is “6 ms/3 ms”, which is 2. Also, in the case of the sending process 20Z, the ratio is “9 ms/3 ms”, which is 3. Since the reference value is 1 in the embodiment 1, the reference value in the embodiment 3 is also set 1. In this case, as illustrated in FIG. 12, the threshold value of the sending process 20Y is 2, and the threshold value of the sending process 20Z is 3. The reference value may be set with respect to each of the sending processes 20.

Then, when the difference between the value of the additional data 43 and the value of the monitoring data 42 is the threshold value or less, the monitoring thread 32 judges the sending process 20 as being normal. Otherwise, when the difference is larger than the threshold value, the monitoring thread 32 judges the sending process 20 as being abnormal.

### Effects of the Embodiment 3

As described above, in the process monitoring device 10 according to the embodiment 3, the receiving process 30 can monitor the states of the multiple sending processes 20. This eliminates the need for installing complicated processes when the states of the multiple sending processes 20 are to be monitored and thus enables monitoring the states of the multiple sending processes 20 by a simple configuration.

### REFERENCE SIGNS LIST

10: process monitoring device, 11: processor, 12: memory, 13: external storage, 14: peripheral unit, 15, 16, 17: signal line, 111: process, 112: thread, 113: OS, 20, 20Y, 20Z: sending process, 21: sending thread, 22: acquiring thread, 23: controlling thread, 30: receiving process, 31: receiving thread, 32: monitoring thread, 41: communication data, 42, 42A, 42B, 42C: monitoring data, 43: additional data, 44: change information, 45: priority information, 46: termination information.

1. A process monitoring device comprising:
a sending process to send communication data periodically; and
a receiving process to receive the communication data sent by the sending process,
wherein the receiving process includes a monitoring thread to generate monitoring data at every reference interval and to output the generated monitoring data to a memory,
wherein the sending process includes
an acquiring thread to acquire the monitoring data from the memory, and
a sending thread to send the monitoring data acquired by the acquiring thread, to the receiving process as additional data together with the communication data, and
wherein the monitoring thread judges a state of the sending process depending on how many times ago the monitoring data, which the additional data sent by the sending thread is, was generated.

2. The process monitoring device according to claim 1,
wherein the monitoring thread sends change information to the sending process when judging the sending process as being abnormal, and
the sending process further includes a controlling thread to gradually increase an operation priority of the acquiring thread when the change information is sent.

3. The process monitoring device according to claim 2,
wherein, when the communication data is sent after the change information is sent, the sending thread sends the communication data by adding priority information indicating the operation priority.

4. The process monitoring device according to claim 2,
wherein, when judging the sending process as being normal after judging the sending process as being abnormal, the monitoring thread sends termination information to the sending process.

5. The process monitoring device according to claim 1,
wherein, in an initial state, the acquiring thread operates at the lowest operation priority among threads operating in the sending process.

6. The process monitoring device according to claim 1,
wherein the reference interval is an interval within a period with which the sending process sends the communication data.

7. The process monitoring device according to claim 1, wherein
a plurality of the sending processes operate, and
the reference interval is the greatest common divisor of periods with which the plurality of sending processes respectively send the communication data.

8. The process monitoring device according to claim 1,
wherein the monitoring thread generates a different value as the monitoring data each time the monitoring data is generated.

9. A process monitoring method in a process monitoring device including a sending process to send communication data periodically and a receiving process to receive the communication data sent by the sending process, the method comprising:
generating monitoring data at every reference interval and outputting the generated monitoring data to a memory, by a monitoring thread operating in the receiving process;
acquiring the monitoring data from the memory, by an acquiring thread operating in the sending process;
sending the monitoring data acquired by the acquiring thread to the receiving process as additional data together with the communication data, by a sending thread operating in the sending process; and
judging, by the monitoring thread, a state of the sending process depending on how many times ago the monitoring data, which the additional data sent by the sending thread is, was generated.

10. A non-transitory computer readable medium storing a process monitoring program for causing a computer to execute a sending process to send communication data periodically and a receiving process to receive the communication data sent by the sending process, wherein
the receiving process includes a monitoring thread to generate monitoring data at every reference interval and to output the generated monitoring data to a memory,
the sending process includes
an acquiring thread to acquire the monitoring data from the memory, and
a sending thread to send the monitoring data acquired by the acquiring thread, to the receiving process as additional data together with the communication data, and
the monitoring thread judges a state of the sending process depending on how many times ago the monitoring data, which the additional data sent by the sending thread is, was generated.
